(19) United States
(12) Patent Application Publication
(10) Pub. No.: US 2009/0072522 A1
(43) Pub. Date: Mar. 19, 2009

(54) Airbag module

(75) Inventors: Nick Eckert, Berlin (DE); Rolf Lazar, Berlin (DE); Rafael Fagir, Berlin (DE); Mathias Cohrs, Berlin (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/285,017

(22) Filed: Sep. 26, 2008

Related U.S. Application Data
(63) Continuation of application No. PCT/EP2007/002707, filed on Mar. 22, 2007.

(30) Foreign Application Priority Data
Mar. 28, 2006 (DE) 20 2006 005 319.0

(51) Int. Cl. B60R 21/20

(52) U.S. Cl. 280/728.2

(57) ABSTRACT

An airbag module with an airbag packed in foil under vacuum, including a gas generator and a covering cap. The foil includes at least one predetermined tearing point. The foil is connected or can be at least partially connected to the covering cap in sections that lie next to the tear-open edges of the covering cap. The connection can be configured to take place only upon deployment of the airbag.

### CROSS-REFERENCE TO RELATED PATENT APPLICATIONS

This application is a Continuation of International Application No. PCT/EP2007/002707, filed Mar. 22, 2007, which was published in German as WO 2007/112887 and is incorporated herein by reference in its entirety.

### BACKGROUND

The present application relates generally to the field of airbag modules. In particular, the application relates to the packaging of an airbag in a module.

### SUMMARY

One disclosed embodiment relates to an airbag module with an airbag packed in foil under vacuum, including a gas generator and a covering cap. The foil includes at least one predetermined tearing point. Additionally, the foil is connected or can be at least partially connected to the covering cap in sections that lie next to the tear-open edges of the covering cap. Further, the connection can be configured to take place only upon deployment of the airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a section of a foil with a tear-open seam as the predetermined tearing point, according to an exemplary embodiment.

FIG. 2 shows a section of a foil with an impressed contour as the predetermined tearing point, according to an exemplary embodiment.

FIG. 3a-c shows tear-open geometries of the foil and of the associated covering cap, according to an exemplary embodiment.

FIG. 4 shows an embodiment of a foil connected to the covering cap, according to an exemplary embodiment.

FIG. 5 shows an embodiment with sharp edges on the inside of the covering cap.

FIG. 6 shows an embodiment with a heating wire.

FIG. 7 shows embodiments with adhesive agents.

### DETAILED DESCRIPTION

Airbags may be packed in airbag modules in a folded state in foil under vacuum. These folded packages are subsequently inserted into the airbag modules. In certain situations it may be possible for a folded package to tear open, in the event of a crash, in an undefined manner in terms of force and geometrical profile. As described further below, the disclosed embodiments of an airbag module are configured so that the foil tears and the airbag deploys in a defined and predictable manner.

According to a disclosed embodiment, an airbag module includes an airbag packed in foil under vacuum, with a gas generator and a covering cap. The foil includes at least one predetermined tearing point. Further, the foil is connected to or can be at least partially connected to the covering cap in sections that lie next to the tear-open edges of the covering cap.

In the case of airbag modules, predetermined tearing points in the covering caps are known. The predetermined tearing points have been inserted in the form of material weakenings during the production of the covering caps. Additionally, it is known from DE 199 07 742 A1, which is herein incorporated by reference in its entirety, to only produce material weakening in the event of a crash by inserting a heating wire into the covering cap at the designated tear-open points of the covering cap. Thus, in the basic state, the covering cap includes a continuous wall without gaps or visible edge notchings. The predetermined tearing points have previously been provided only in the covering caps in airbag modules. Conventionally, the tearing points have a thickness in the millimeter range. No conventional predetermined tearing points have been provided in the foils, which are only a few tenths of a millimeter thick, for the packing of the airbag. The presence of the predetermined tearing point in the event of a crash means that it does not have to be provided beforehand.

The predetermined tearing point is preferably provided in the region of the tear-open edges of the covering cap. Thus, during tearing open of the covering cap, the tearing edges of the foil lie approximately in the region of the tear-open edges of the covering cap.

The predetermined tearing point of the foil can differ in design. The first basic option is for the foil to already have a predetermined tearing point before the airbag is packed. Therefore, a tear-open seam or an impressed contour may be provided as the predetermined tearing point. It is advantageous for the predetermined tearing point to be provided in one layer when a multi-layer foil is used. More particularly, the predetermined tearing point should be configured on the outer layer that faces the covering cap.

According to an exemplary embodiment, the foil is connected at least partially to the covering cap in sections that lie next to the tear-open edges of the covering cap. Thus, it is possible for an all-over, linear or spot-shaped connection to be provided. As a result of the aforementioned connection, movement of the covering cap and of the foil relative to each other can be prevented. Therefore, during opening, stress can be concentrated on the relatively narrow regions of the foil below the tear-open edges of the covering cap. Thus, a rapid and defined tearing open of the foil can occur.

The second basic design of the predetermined tearing point is wherein the foil has a predetermined tearing point only upon or directly before firing of the gas generator.

According to an exemplary embodiment, the foil includes a mechanically produced predetermined tearing point. This can be achieved, for example, by sharp edges on the inside of the covering cap. When the airbag is deployed, the foil is pressed against the sharp edges. As a result, the foil is perforated at these points, i.e. is locally weakened.

According to a further exemplary embodiment, the foil includes a thermally produced predetermined tearing point. At least one heating wire can be provided to produce the predetermined tearing point. According to a preferred embodiment, the heating wire can be arranged between the covering cap and the foil.

According to a yet further exemplary embodiment, the foil can be at least partially connected to the covering cap in sections that lie next to the tear-open edges of the covering cap. For example, the inside of the covering cap can include adhesive agents that the foil can be pressed against when the airbag is deployed. Double-sided adhesive tape or structural elements with a high coefficient of friction can be included as the adhesive agents. However, a corresponding structure may also be molded onto the elements of the covering cap.

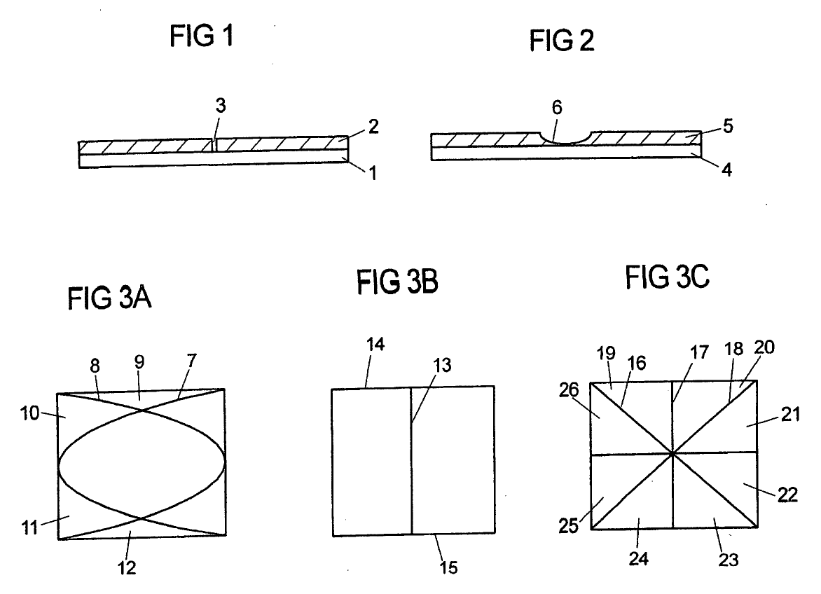

FIG. 1 illustrates a section of a foil that includes two layers 1 and 2. The first layer 1, that bears against an airbag when the latter is packed, is of continuous design. The second layer 2, that faces the covering cap of the airbag module, has a tear-open seam 3 in the form of a slot, i.e. the layer 2 is severed at this point. As a result, the foil is weakened at the tear-open seam 3 and preferably tears open at the tear-open seam 3 when the airbag is deployed. The severing of the layer 2 may also be of interrupted design here, i.e. perforated linearly.

FIG. 2 shows a two-layer foil, according to an exemplary embodiment. A first layer 4 bears against the airbag. The first layer 4 can be of continuous design. A second layer 5 includes an impressed contour 6 as the predetermined breaking point. The contour can be of interrupted design along the contours profile. The contour as the material weakening can be produced mechanically or thermally.

FIGS. 3a to 3c illustrate how the predetermined breaking points can run in the foil, according to an exemplary embodiment. The foil section lying below the covering cap is illustrated. The predetermined breaking points of the covering cap include the same profile. In the embodiment of FIG. 3a, the predetermined breaking points are provided in the boundary lines of two approximately parabolic sections 7, 8. When the airbag is deployed, one of the sections will tear open first. If, for example, the section 7 tears open first, edge sections 9, 10, 11, 12 remain and then tear along the part of the parabolic section 8 that is still remaining. In the embodiment of FIG. 3b, predetermined breaking points run along a center line 13 and two boundary lines 14, 15. Thus, only two parts are unfolded. According to the exemplary embodiment of FIG. 3c, predetermined breaking points are provided along lines 16, 17, 18 running in a star-shaped manner. Therefore eight sections 19 to 26 unfold along the edge lines.

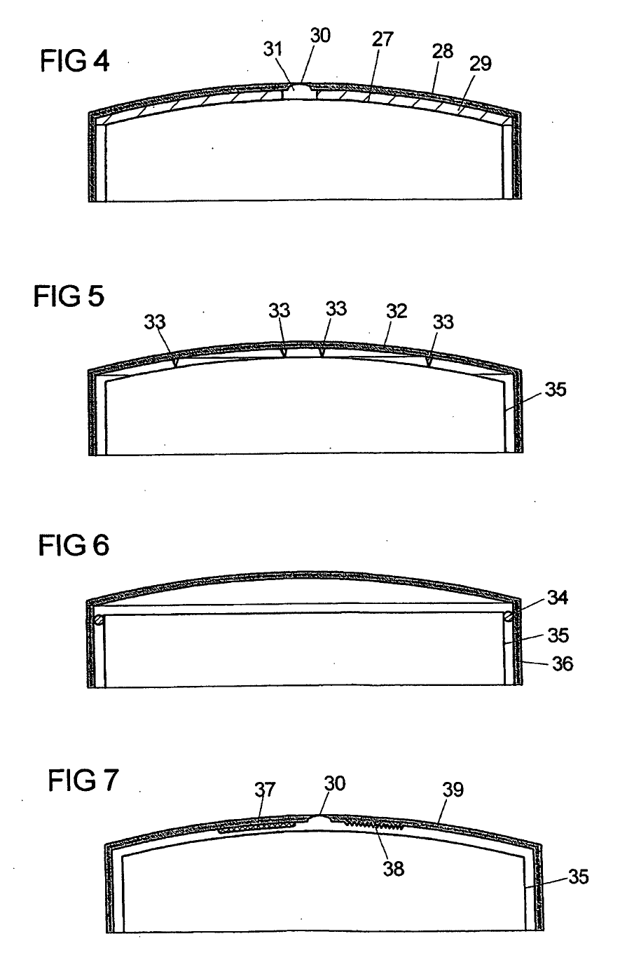

According to the exemplary embodiment of FIG. 4, when the airbag module is installed, the upper section 27 of the foil that surrounds the folded airbag is already connected to the inside of the assigned covering cap 28. This can take place, for example, by means of an adhesive layer 29. In the aforementioned embodiment, the foil is not adhesively bonded in the region of a tear-open edge 30 of the covering cap. As a result of the adhesive bonding, the stress during the opening of the airbag is concentrated to the relatively narrow region of the foil below the tear-open edge 30 as there is a lack of relative movement between the foil and the covering cap. This operation can also be assisted by the foil having a tear-open seam 31 below the tear-open edge 30.

According to the exemplary embodiment of FIG. 5, the inside of the covering cap 32 includes sharp edges 33. Further, the foil does not include a predetermined tearing point before deployment of the airbag. The predetermined tearing point is produced by means of the sharp edges 33. Upon deployment of the airbag, the foil presses against the sharp edges 33. In the process, the foil is perforated such that the foil subsequently tears open at the perforations.

According to the exemplary embodiment of FIG. 6, the foil does not include a predetermined tearing line before deployment of the airbag. A heating wire 34 is included to produce a predetermined tearing line. The heating wire can be arranged between the foil 35 and the covering cap 36. When deployed, the heating wire heats the foil 35 such that the foil 35 is weakened at a predetermined point. Thus, the foil 35 preferably tears open at the predetermined point.

The embodiments of FIG. 7 are comparable to the embodiment of FIG. 4. In the embodiment of FIG. 4, the foil is connected to the covering cap in certain sections upon installation. In the embodiment of FIG. 7, the connection to the covering cap takes place only upon deployment of the airbag. For example, a double-sided adhesive tape 37 or structural elements 38 that have a high coefficient of friction are provided on the inside of the covering cap 39, thereby providing a connection. Further, structural elements 38 can be regions of the inside of the covering cap 39 with an integrally formed ribbed or hook structure. Furthermore, segments with a roughened surface (i.e., a hook side of a touch-and-close fastener or element with a sandpaper-like structure) that are attached to the inside can be included. When the airbag is deployed, the foil 35 can press against the adhesive tape 37 or against the structural elements 38. Thus, the foil 35 is held while being freely movable in the region of the tear-open edge 30 of the airbag cap and therefore preferably tears open there.

The priority application, German Patent Application No. 20 2006 005 319.0, filed Mar. 28, 2006, including the specification, drawings, claims and abstract, is incorporated herein by reference in its entirety.

Given the disclosure of the application, one versed in the art would appreciate that there may be other embodiments and modifications within the scope and spirit of the application. Accordingly, all modifications attainable by present application are to be included as further embodiments of the present application. The scope of the present application is to be defined as set forth in the following claims.

What is claimed is:

1. An airbag module comprising:
a gas generator, an airbag packed in foil under vacuum, and
a covering cap,
wherein the foil includes at least one predetermined tearing point, and wherein the foil is either connected or partially connected to the covering cap in sections that lie next to the tear-open edges of the covering cap, or in that the connection between the foil and the covering cap only occurs only upon deployment of the airbag.

2. The airbag module of claim 1, wherein the predetermined tearing point is provided in the region of the tear-open edges of the covering cap.

3. The airbag module of claim 1, wherein the foil already includes a predetermined tearing point before the airbag is packed.

4. The airbag module of claim 3, wherein the predetermined tearing point comprises a tear-open seam or an impressed contour.

5. The airbag module of claim 3, wherein the foil comprises multiple layers and the predetermined tearing point is provided in only one of the layers.

6. The airbag module of claim 5, wherein the predetermined tearing point is provided in the layer of the foil adjacent the covering cap.

7. The airbag module of claim 1, wherein an all-over, linear or spot-shaped connection between the foil and the covering cap is provided.

8. The airbag module of claim 1, wherein the module is configured so that the predetermined tearing point is formed in the only upon or directly before firing of the gas generator.

9. The airbag module of claim 8, wherein the foil includes a mechanically produced predetermined tearing point.

10. The airbag module of claim 9, wherein an inside surface of the covering cap includes sharp edges configured to produce the predetermined tearing point.

11. The airbag module of claim 8, wherein the foil includes a thermally produced predetermined tearing point.

12. The airbag module of claim 8, wherein the module includes at least one heating wire is provided to produce the predetermined tearing point.

13. The airbag module of claim 12, wherein the heating wire is arranged between the covering cap and the foil.

14. The airbag module of claim 1, wherein the inside of the covering cap includes adhesive agents against which the foil can be pressed when the airbag is deployed.

15. The airbag module of claim 14, wherein the adhesive agent comprises double sided tape or structural elements with a high coefficient of friction.

16. An airbag module comprising a gas generator, an airbag and a covering cap, wherein the airbag is vacuum packed in foil, and wherein both the covering cap and the foil are configured to tear into predetermined sections, and wherein the location wherein the foil tears is adjacent to the location where the covering cap tears so that when the airbag is inflated by gas provided by the gas generator the foil and the covering cap separate into the predetermined sections thereby allowing the airbag to deploy.
